(19) United States
(12) Patent Application Publication
(10) Pub. No.: US 2006/0078254 A1
(43) Pub. Date: Apr. 13, 2006

(54) Vertically coupling of resonant cavities to bus waveguides

(76) Inventors: Kostadin D. Djordjev, San Jose, CA (US); Chao-Kun Lin, Fremont, CA (US); Michael R. T. Tan, Menlo Park, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/961,940

(22) Filed: Oct. 8, 2004

(51) Int. Cl. G02B 6/42; G02B 6/26

(52) U.S. Cl. 385/32; 385/31; 385/39; 385/43

(57) ABSTRACT

Embodiments of the invention involve a monolithic vertical configuration for coupling a ring resonator and a bus waveguides. The monolithic vertical coupling arrangement, with the epitaxial grown coupling between the waveguide and the resonator, provides control of the coupling coefficient. The vertical coupling arrangement allows for different material compositions in the waveguide and resonator structures, e.g. active quantum well resonators and transparent waveguides, to facilitate the design of active WDM components.

### STATEMENT REGARDING FEDERALLY SPONSORED RESEARCH OR DEVELOPMENT

The invention was made in part with Government support by Defense Advanced Research Projects Agency (DARPA) under Grant Number: MDA972-03-3-0004. The Government has certain rights in the invention.

### BACKGROUND OF THE INVENTION

Many practical devices incorporating micro-cavities have been demonstrated lately, including channel-dropping filters, WDM demultiplexers, and active switches. The spectral selectivity inherent in these resonant structures makes them attractive for applications to wavelength division multiplexed (WDM) systems. By coupling to bus waveguides, a single ring may completely transfer a resonant wavelength from the input waveguide to another waveguide and offer superior performance compared to standing-wave resonators. The devices can be very compact and thus amenable to large-scale integration. Furthermore, with slight modifications of the device design, one can easily envision that the same basic structure can be used to incorporate tunable lasers, detectors, and modulators into a WDM system that greatly increases its functionality.

There are two main configurations utilizing the coupling between the microcavity (or resonator or resonant cavity or ring cavity) and the bus waveguide. The first approach uses lateral coupling and the second approach uses vertical coupling.

FIG. 1A depicts one typical arrangement for lateral coupling, where a resonant cavity 100a is located adjacent to a waveguide 101a, with a small air gap between them. The waveguide 101a has a dimension on the order of 0.4 μm, while the air gap 103 has a dimension on the order of 0.1 μm. Cladding 102 covers both the waveguide 101a and the resonator 100a. This configuration has several disadvantages. For example, the very small dimensions (˜0.1 μm), are very difficult to fabricate and are not easily reproducible, and require using expensive e-beam tools. This configuration also requires a relatively deep (as compared with the size of the air gap) etch with vertical sidewalls in the coupling area, where the proximity effects become important. Another disadvantage is that the waveguides 101a and the ring cavity resonator 100a have similar material properties, e.g. the same epi-layer. This hinders the utilization of this configuration in active devices, where an active ring cavity with absorbing QWs and passive transparent waveguide are desirable.

Vertical coupling can have different arrangements. FIG, 1B depicts one typical arrangement for vertical coupling, where the resonator 100c is located above the waveguide 101c. The resonator is supported by post 105, wherein there may be an air gap 106 between the post and the waveguide 101c. A portion of the resonator is located above a portion of the waveguide to allow for coupling. This arrangement offers precise control of the coupling coefficient by epitaxial growth, e.g. of the cladding layers, rather than using a deep etch to create an air gap (FIG. 1A) or by precise placement of the resonator and the waveguide. Moreover, the waveguides and the ring cavity could be grown with different material compositions, thus active devices become possible. This arrangement can be fabricated by wafer or polymer bonding of the original epi-structure to a transfer substrate. This arrangement allows for the use of high-index, small dimension single mode bus waveguides, which have better coupling to the resonator, but very poor coupling to the input/output fibers for the waveguide. This arrangement also allows for deeply etched ring cavities which provides low energy leakage into the substrate and thus high Q for the resonator. However, this configuration has several disadvantages. For example, this the fabrication process is not monolithic and is very complicated, and wafer-scale fabrication is questionable. Moreover, the resonator is air-suspended and supported by the post, which causes problems with mechanical stability and current/field uniformity when electrically pumped.

Another arrangement for vertical coupling is shown in FIG. 1C, which is similar to the arrangement of FIG. 1B, except that there is no post, and the resonator 100d is supported by the waveguide 101d and its substrate 107. The waveguide of this arrangement is known as a buried heterostructure (BH) bus waveguides. The etched bus waveguides are planarized and the resonator is defined on top of the wafer substrate 107. The resonator is supported by the substrate, and a portion of the resonator is located above a portion of the waveguide to allow for coupling. This arrangement has good mechanical stability and current/field uniformity when electrically pumped. This arrangement also has poor coupling to the ring cavity (due to different field dimensions and velocity mismatch), but has very good coupling to the input/output fibers of the waveguide. One disadvantage is that the fabrication process must include a smooth planarization process. Another disadvantage is that the resonator has shallow etched ring cavities, which allows energy to leak into the substrate, thus causing high loss (low Q).

For additional information on these types of structures, see Hryniewicz, J. V. et al., “Higher Order Filter Response in Coupled Microring Resonators,” IEEE Photonics Technology Letters, Vol. 12, No. 3, p. 320-322, (March 2000); Djordjev, Kostadin et al., “Vertically Coupled InP Microdisk Switching Devices with Electroabsorptive Active Regions,” IEEE Photonics Technology Letters, Vol. 14, No. 8, p. 1115-1117, (August 2002; Djordjev, Kostadin et al., “High-Q Vertically Coupled InP Microdisk Resonators,” IEEE Photonics Technology Letters, Vol. 14., No. 3, p. 331-333, (March 2002); Choi, Seung June et al., “Microdisk Lasers Vertically Coupled to Output Waveguides,” IEEE Photonics Technology Letters, Vol. 15, No. 10, p. 1330-1332, (October 2003); Choi, Seung June et al., “Microring Resonators Vertically Coupled to Buried Heterostructure Bus Waveguides,” IEEE Photonics Technology Letters, Vol., 16, No. 3, p. 828-830, (March 2004); and Rabus, D. G. et al., “MMI-Coupled Ring Resonators in GaInAsP-InP,” IEEE Photonics Technology Letters, Vol. 13, No. 8, p. 812-814, (August 2001); all of which are hereby incorporated herein by reference.

### BRIEF SUMMARY OF THE INVENTION

In accordance with the invention, a vertical configuration for coupling a ring resonator and a bus waveguide is used. The vertical coupling arrangement, with the epitaxial grown coupling between the waveguide and the resonator, provides control of the coupling coefficient. The vertical coupling arrangement allows for different material compositions in the waveguide and resonator structures, e.g. active quantum well resonators and transparent waveguides, to facilitate the design of active WDM components.

### BRIEF DESCRIPTION OF THE DRAWINGS

FIGS. 1A-C depict different arrangements of resonators and waveguides;

FIGS. 2A-2B depict an arrangement of a resonator and a waveguide, according to embodiments of the invention;

FIGS. 3A-H depict an example of a method for fabricating the arrangement of FIGS. 2A-2B, according to embodiments of the invention.;

FIGS. 4A-4C depict top views of the masks used in FIGS. 3E-3H; and

FIGS. 5A-5I depict perspective views of the method of FIGS. 3A-3H.

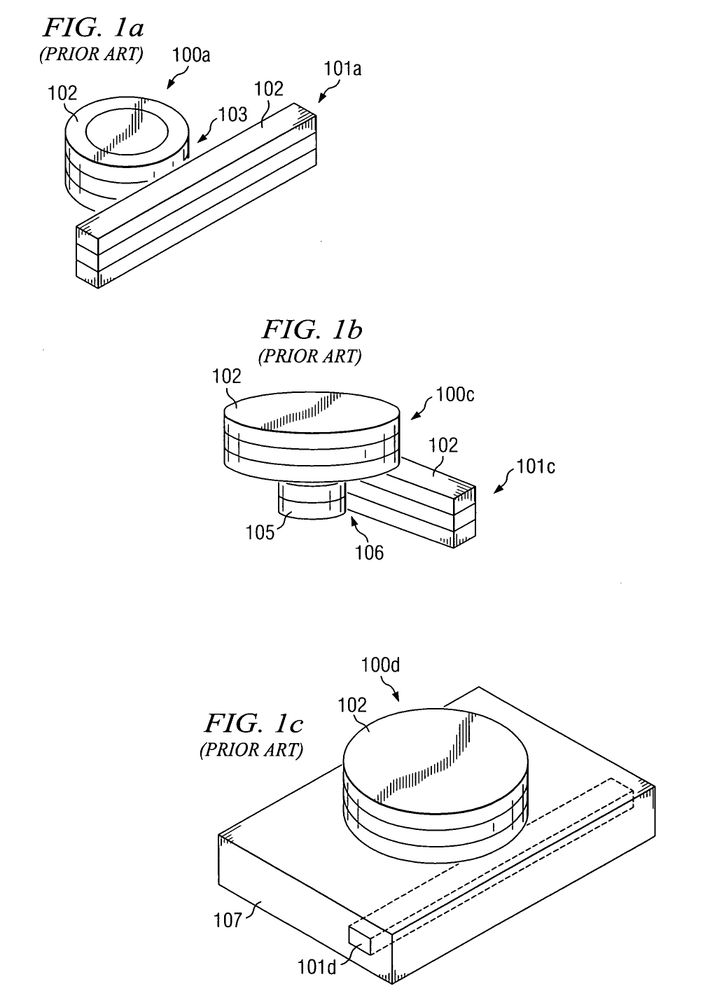

### DETAILED DESCRIPTION OF THE INVENTION

One embodiment of the invention is to use deeply etched resonators to have low energy leakage out of the cavity and thus high Q.

Another embodiment of the invention is to have narrow, high index bus waveguide below the cavity and high-index ring waveguides to decrease the loss in the resonators and improve the mode and group velocity matching between the waveguide and the resonator.

A further embodiment of the invention is to use BH waveguides distant from the cavity to offer low-coupling loss to the input/output fibers.

Another embodiment of the invention is to have the resonator monolithically integrated to the wafer surface for better mechanical stability and current/field uniformity when electrically pumped.

Active micro-cavity devices may be the building blocks for future photonic circuitry. They offer compact size and versatility. One can design numerous functional components, switches, modulators, lasers, and detectors on a single chip.

One use for a resonant cavity that is coupled to a waveguide is to remove (or filter) a particular wavelength or range of wavelengths from the waveguide. The light coupled into the micro-ring or resonator through a bus waveguide will circulates around the ring many times, leaking light back into the waveguide on each pass. On resonance, this light will be out of phase with the original light transmitted past the ring, and under the resonant conditions will add up to completely cancel out the original transmitted wave. This condition occurs when the percent loss experienced in one roundtrip pass through the resonator is equal to the percent of light coupled in a single pass from the waveguide to the ring. This micro-ring then allows for complete extinction of the light at resonance. One of the main challenges when designing a micro-ring device is to decrease the losses and optimize the coupling coefficient.

The loss is a result from different mechanisms, e.g. scattering from sidewall roughness, leakage into the substrate, bending loss, and/or coupling loss. For optimal performance, each of the sources should be minimized. Optimizing the dry etching recipes and masking could minimize the scattering from sidewall roughness. Bending loss is generally very small in the semiconductor material, due to the large index contrast. Using embodiments of the invention, the loss due to the leakage into the substrate and the coupling loss to the output fibers will be substantially reduced.

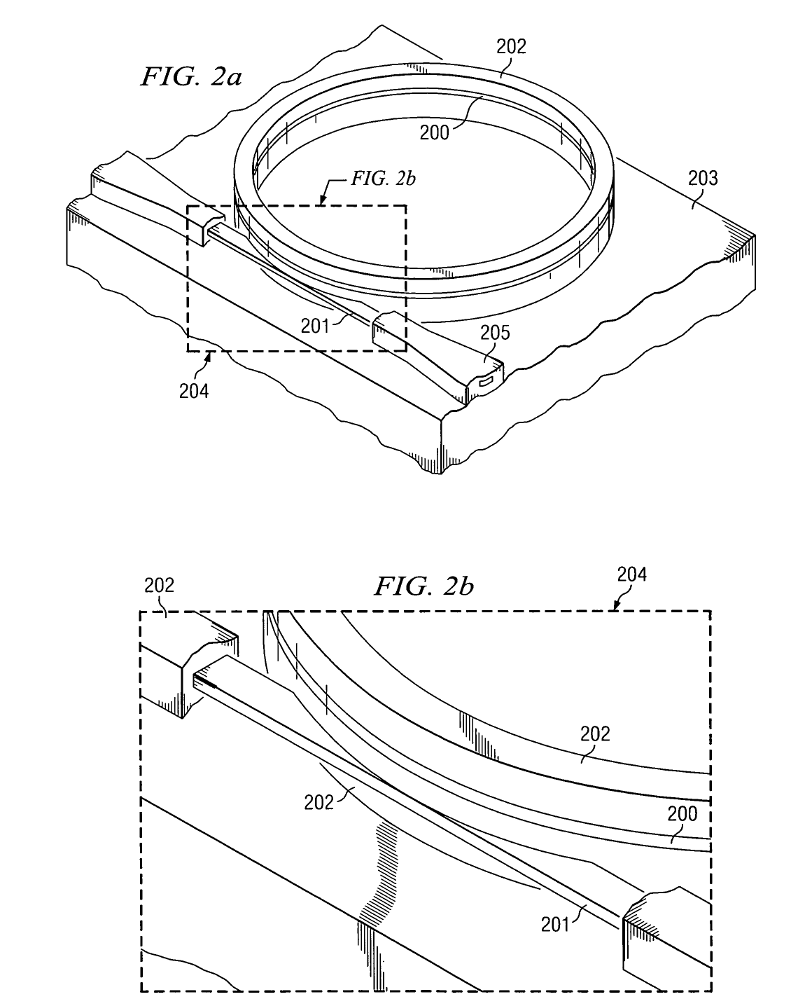

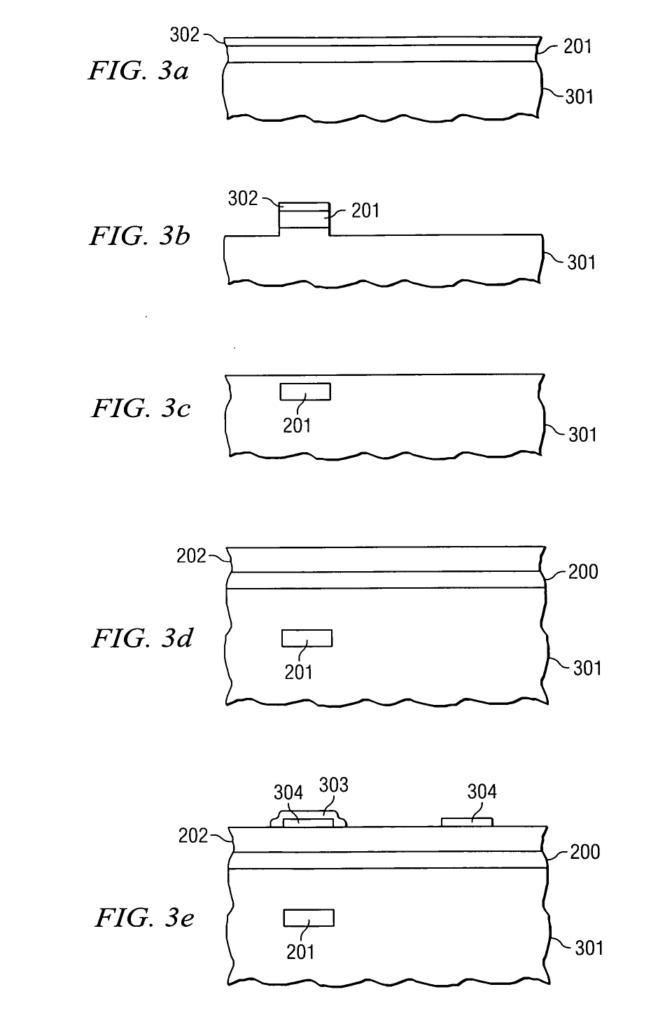

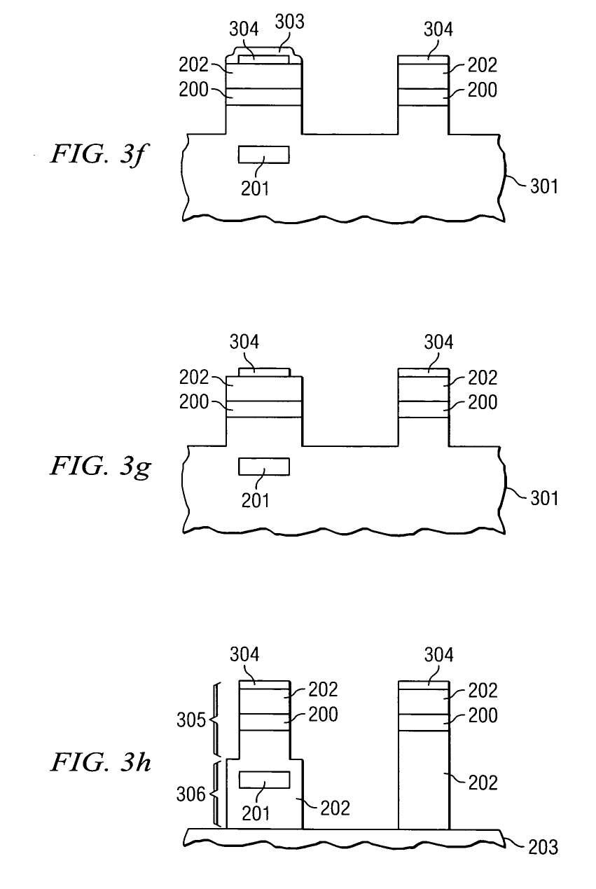

FIGS. 2A-2B depict an arrangement of a resonator and a waveguide, according to embodiments of the invention. FIG. 2A depicts a perspective view of the arrangement. FIG. 2B depicts an in-set of the coupling region 204 of FIG. 2A. FIG. 2A also depicts the cross-section line for FIGS. 3A-3H. Note that this arrangement is by way of example only as embodiments of the invention may be used to form another arrangement.

The arrangement includes a resonator 200 that is coupled with a waveguide 201. The resonator 200, encased in cladding 202, is supported by the substrate 203. The resonator 200 may be epitaxially grown on the substrate. The waveguide 201 is a BH waveguide. Note that the view of FIGS. 2A and 2B the cladding has been removed for a portion of the waveguide to more readily depict the coupling region, but would be present in operational devices. Note that the cladding of the waveguide tapers down in the coupling region 204 and widens outside 205 of the coupling region 204. The waveguide core is a constant width throughout the wafer and its width is equal to the width of the ring cavity for better coupling (equal phase velocities and similar mode profiles). In the coupling region below the cavity, the width of the cladding is equal to the width of the bus core and equal to the width of the ring cavity (the cladding may be a little bit wider because of the process tolerances). In this region the bus waveguide is a high-index waveguide. Far from the cavity, the cladding width tapers and becomes much wider than the bus core. This forms a BH waveguide having a small high-index core effectively buried in a large low-index cladding. In other words, the bus has an adiabatic taper from a BH waveguide (wide) far from the cavity to a high-index waveguide below the cavity (narrow). Note that adiabatic means a slow change so as to minimize or eliminate reflections of light traveling down the waveguide.

FIGS. 3A-3H depict an example of a method for fabricating the arrangement of FIGS. 2A-2B, according to embodiments in accordance with the invention. FIGS. 3A-3H are a sectional view of the arrangement of FIGS. 2A and 2B, along the cross sectional line indicated in FIG. 2A.

The exemplary process starts, as shown in FIG. 3A, by growing (via MOCVD) the initial epi-structure on InP or GaAs wafer or substrate 301. The waveguide structure comprises the buffer layer 302 and the bus waveguide core layer 201. The layers could be doped or undoped, with active region or without, depending on the particular application.

In FIG. 3B, the bus waveguide 201 is defined by optical lithography, a mask, and plasma discharge (dry etching) or wet etching. Note that the bus core would have the same width through out its path.

In FIG. 3C, the wafer 301 is cleaned and then planarized in a metaloorganic chemical vapor deposition (MOCVD) reactor, by performing selective area growth with InP or GaAs material respectively, with enough thickness to cover the core layer 201. At this point, if the corrugation of the top surface is considerable, additional steps could be undertaken to reduce the corrugation, for example etch-back techniques.

In FIG. 3D, a third MOCVD growth is performed to define the epi-layers of the resonator, including the coupling region, the resonator disk core 200 and top cladding.

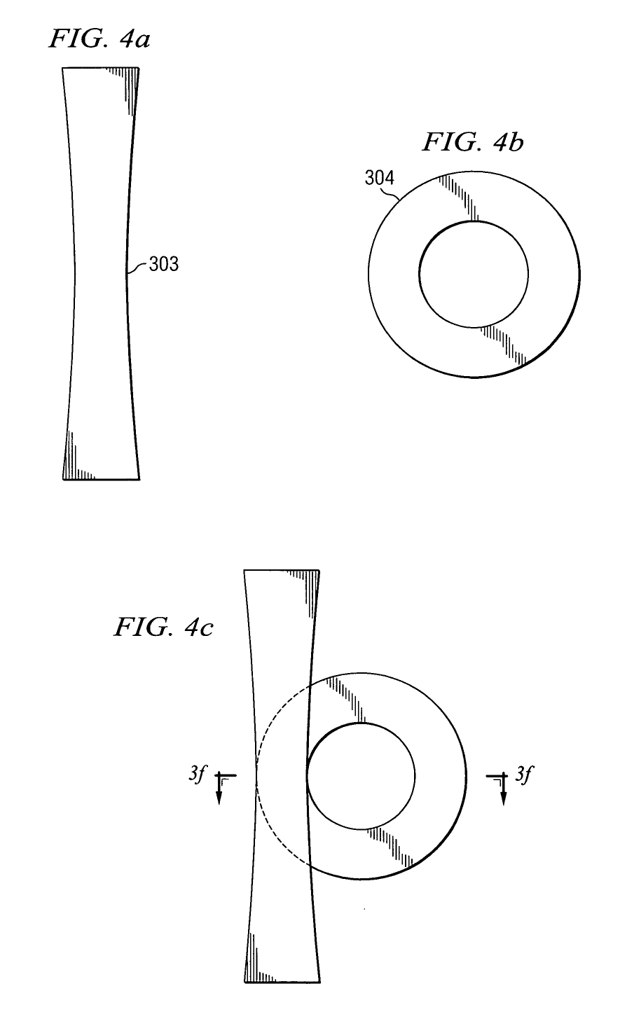

In FIG. 3E, the resonator ring cavity and the BH bus waveguides are defined by using two different mask levels 303 and 304 that can be selectively etched or removed. Examples of masks may be metal masks, a dielectric masks, or a combination of metal/dielectric masks. Other masks that provide good etching selectivity may be used. The first mask 304 is ring-shaped and defines the ring cavity, and the second mask 303 defines the tapered BH bus waveguide. The mask 303 is also shown in FIG. 4A, and the mask 304 is shown in FIG. 4B. FIG. 4C depicts a top view of the arrangement of masks 303 and 304 as shown in FIG. 3E.

In FIG. 3F, a deep dry etch is performed in plasma discharge to form the ring cavity merged with the tapered BH bus waveguide in the coupling region, followed by a selective removal of the second mask 303, as shown in FIG. 3G.

In FIG. 3H, a second dry etch is performed in plasma discharge. This etch is used to transfer the already defined, tapered BH bus waveguide (in FIG. 3F, by mask 303) down to the bus core 201, while completely defining the shape of the ring cavity by mask 304. In other words, the entire structure is etched downward, except for the portion covered by mask 304. This sectional view is showing the coupling region, and portion 306 of the structure is part of the resonator 200, while portion 307 is part of the waveguide 201. This waveguide is narrow close to the cavity, i.e. in the coupling region, to form a high index bus waveguide for better coupling efficiency to the ring. The waveguide widens adiabatically when approaching the input/output ports to form a wide BH waveguide for better coupling efficiency to the input/output fibers. At this point the second mask 304 may be removed from the structure, thus forming the coupled waveguide and resonator depicted in FIGS. 2A-2B. Additional processing may present if one or both of the waveguide and/or the resonator is an active element.

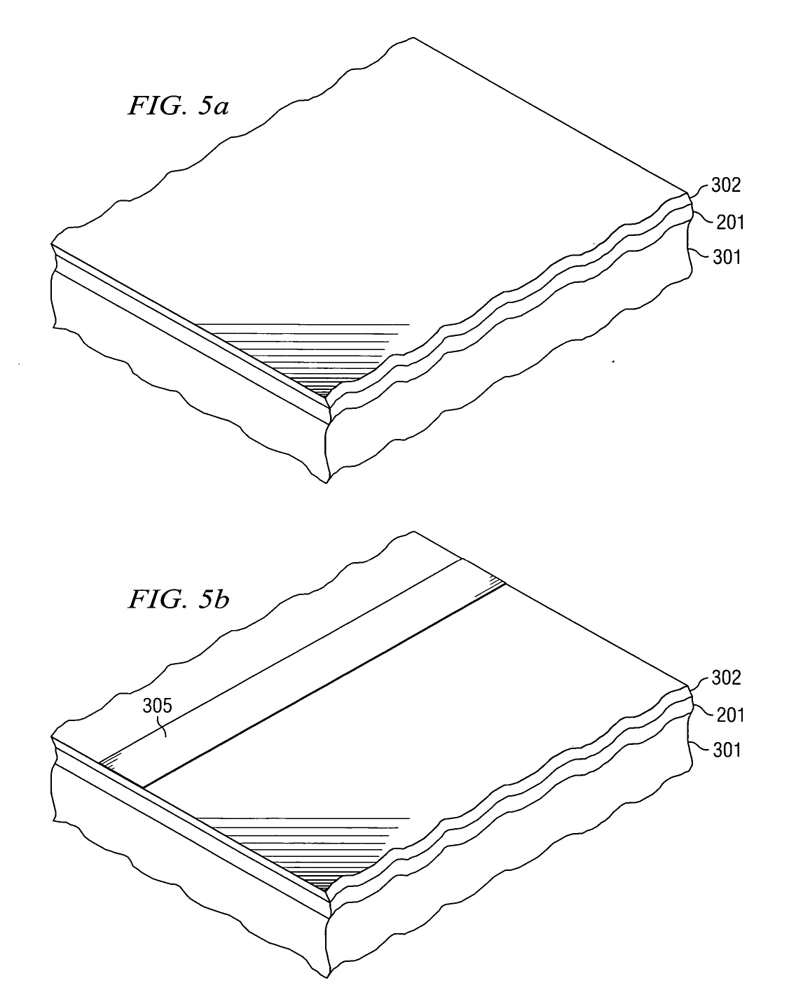

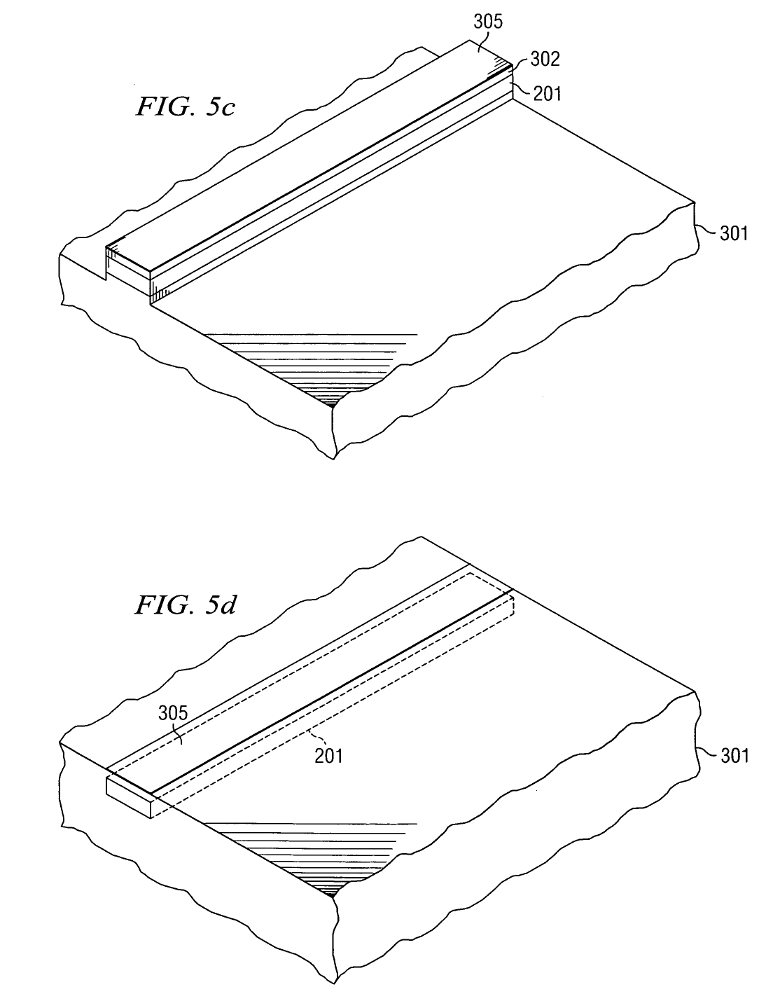

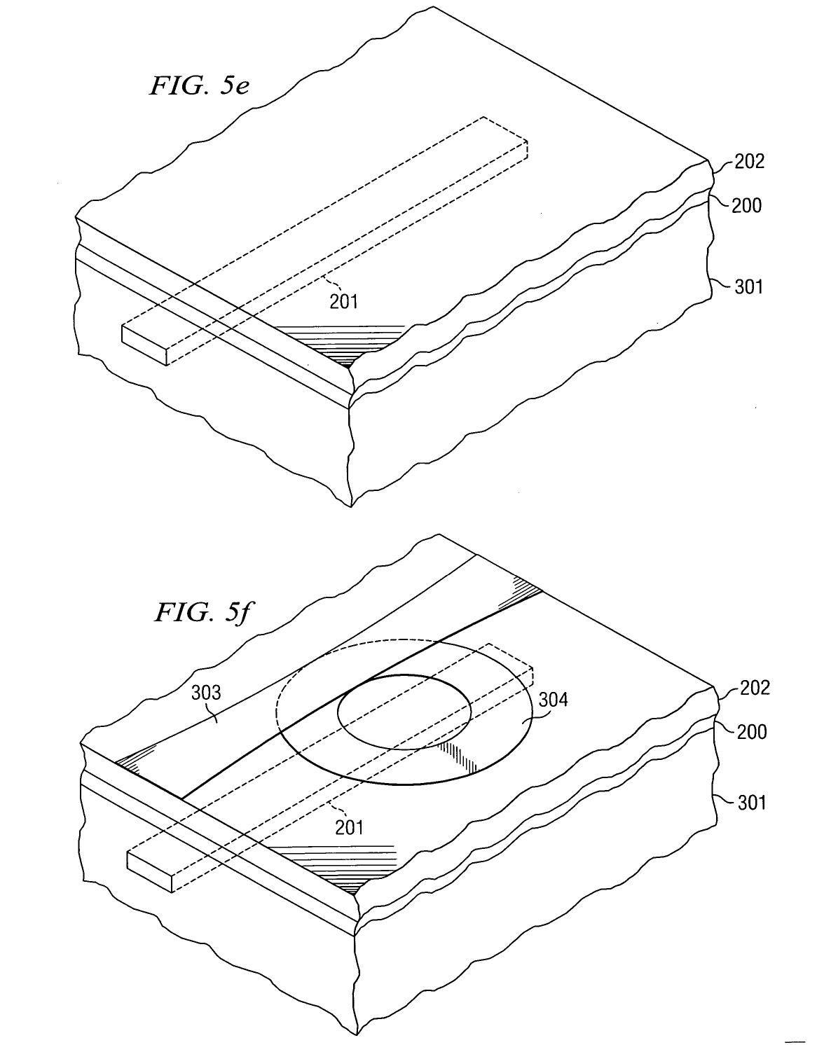

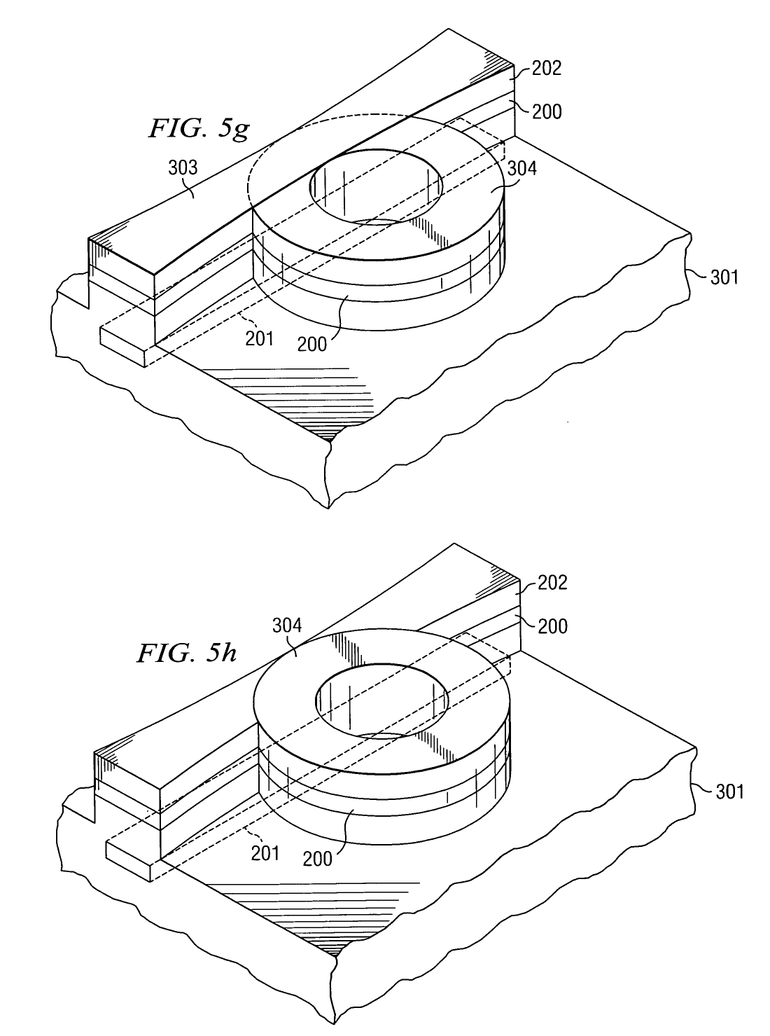

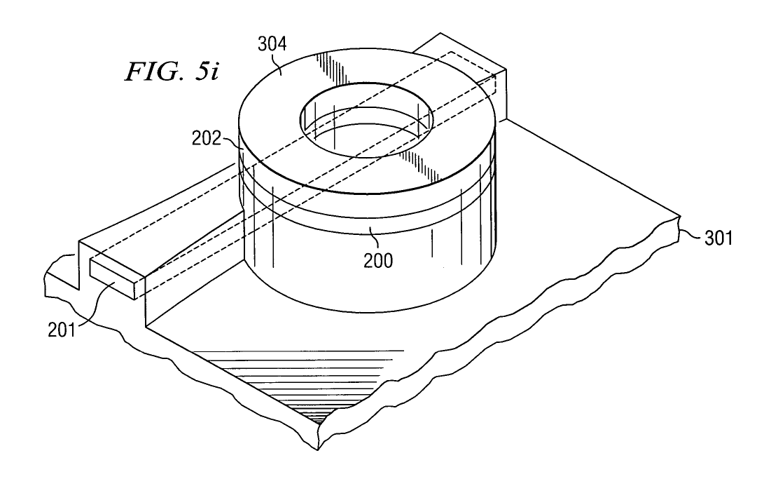

FIGS. 5A-5I depict perspective view of the method of FIGS. 3A-3H. FIG. 5A corresponds with FIG. 3A. FIG. 5B depicts a process step prior to FIG. 3B, wherein a mask 305 is defined, which will be used to form the waveguide. FIG. 5C corresponds with FIG. 3B. FIG. 5D corresponds with FIG. 3C. FIG. 5E corresponds with FIG. 3D. Mask 305 is removed. FIG. 5F corresponds with FIG. 3E. FIG. 5G corresponds with FIG. 3F. FIG. 5H corresponds with FIG. 3G. FIG. 5I corresponds with FIG. 3H.

FIGS. 2A-2B, FIGS. 3A-3H, and FIGS. 5A-5I depict arrangement and method for fabricating the arrangement of vertically coupling resonant cavities to BH bus waveguides. However, embodiments in accordance with the invention may be used to form other types of coupled structures. For example, the resonant cavity can have a racetrack shape, folded cavity shape with turning mirrors, ring shape, a straight section forming a Fabry-Perot cavity, or more generally any shape which could provide a positive feedback to form a resonant cavity. The resonant cavity may perform different functions in different devices. For example, the resonant cavity may provide the filtering characteristics of the device. In another device, the resonant cavity may be connected between two waveguides, wherein one waveguide serves as a drop/output port for particular wavelengths in a DWDM system.

In another embodiment in accordance with the invention, the ring of the resonator may have an active guiding layer (e.g. quantum wells, quantum dots, bulk material, etc.), while the bus is passive. In another device, the ring may be passive and the bus may be active. In another device, the ring and the bus may be active. In another device, the ring and the bus may be passive. In another device, there may be multiple resonant cavities (with each ring being the same as the other rings) coupled to the same bus waveguide, to form a higher order filter with a square-like filter response. In another device, there may be multiple resonant cavities (with each ring having different dimensions than the other rings) coupled to the same bus waveguide, to use the Venier effect to increase the free spectral range of the combined filter.

1. An optical device comprising:
a substrate having a surface;
a waveguide that is located upon the surface; and
a resonator that is vertically coupled to the waveguide in a coupling region of the device, and is located upon the surface.

2. The optical device of claim 1, wherein the resonator is monolithically integrated with the substrate.

3. The optical device of claim 1, wherein the waveguide comprises a material that is different from a material of the resonator.

4. The optical device of claim 3, wherein the waveguide is passive and the resonator is active.

5. The optical device of claim 3, wherein the waveguide comprises a transparent material, and the resonator comprises a plurality of materials to form quantum wells.

6. The optical device of claim 1, wherein the waveguide comprises:
a core layer; and
a cladding layer that surrounds the core layer.

7. The optical device of claim 6, wherein the cladding layer has a diameter that is smaller in the coupling region.

8. The optical device of claim 6, wherein a portion of the cladding layer has a diameter that is tapered, and the diameter varies with the distance from the coupling region such that the diameter is at a minimum in the coupling region.

9. The optical device of claim 8, wherein the diameter varies adiabatically.

10. The optical device of claim 6, wherein the waveguide varies from having characteristics of a high index waveguide to having characteristics of a BH waveguide.

11. The optical device of claim 1, wherein the resonator comprises:
a core layer;
a first cladding layer that is located on one side of the core layer, and
a second cladding layer that is located on a side opposite the one side of the core layer.

12-20. (canceled)
